(19) United States
(12) Patent Application Publication
(10) Pub. No.: US 2012/0221895 A1
(43) Pub. Date: Aug. 30, 2012

(54) SYSTEMS AND METHODS FOR COMPETITIVE STIMULUS-RESPONSE TEST SCORING

(75) Inventors: Daniel J. Mollicone, Philadelphia, PA (US); Christopher G. Mott, Seattle, WA (US)

(73) Assignee: Pulsar Informatics, Inc., Philadalphia, PA (US)

(21) Appl. No.: 13/406,126

(22) Filed: Feb. 27, 2012

Related U.S. Application Data
(60) Provisional application No. 61/447,027, filed on Feb. 26, 2011.

(51) Int. Cl. G06F 11/28

(52) U.S. Cl. 714/32; 714/E11.178

(57) ABSTRACT

Systems and methods for competitively scoring a stimulus-response test are disclosed. Competitive scoring may be based upon: i) a combination of response time and response type (e.g., false start, coincident false start, fast, slow, lapse, timeout, etc.); ii) response time and response latency correction data (e.g., a latency correction parameter corresponding to the test-taker's test system); and iii) a composite score metric comprising any function, rule of categorization, classification system, scoring system and/or the like that can be applied to at least two stimulus-response rounds of one or more test takers to determine a score for each test-taker.

### RELATED APPLICATIONS

This application claims benefit of the priority of U.S. application No. 61/447,027, filed Feb. 26, 2011.

### TECHNICAL FIELD

The invention relates generally to the administration and scoring of stimulus-response tests. Particular embodiments provide systems and methods for administering and scoring stimulus-response tests for multiple testing subjects to compete in such a manner as to increase the reliability of test results by utilizing the competitive instincts of the testing subjects to optimize test performance.

### BACKGROUND

Stimulus-response tests may be used to measure the reaction time of a testing subject in order to quantify one or more of the subject's neurobehavioral states, including but not limited to fatigue state (or its inverse, alertness state). Such tests involve the presentation of one or more stimulus events (or stimulus triggers) to the subject and the measurement or recordation of the characteristics of the stimulus trigger and the subject's subsequent response. Non-limiting examples of stimulus-response tests include: the PVT, digit symbol substitution task (DSST) tests, Stroop tests and the like. Individuals who take or are otherwise subjected to stimulus-response tests may be referred to herein interchangeably as “test-takers,” “testing subjects,” and/or “subjects.”

Reaction-time tests represent a particular example of a stimulus-response test in which the time delay between the stimulus trigger and the subject's response is of particular interest. Reaction-time tests represent a common assessment technique for evaluating human cognitive and neurobehavioral performance. Generally, reaction-time tests involve: presenting a stimulus event to the subject, assessing or recording a time at which the stimulus event is presented, and assessing or recording a time at which the subject responds to the stimulus. See, e.g., U.S. patent application Ser. No. 12/776,142, entitled Systems and Methods for Evaluating Neurobehavioral Performance from Reaction Time Tests, K. Kan, C. Mott et al., inventors, (USPTO Pub. No. 2010/0311023) the entirety of which is hereby incorporated by reference, for a method to process reaction time data using weighting functions.

As a non-limiting example, one use of stimulus-response tests, generally, and reaction-time tests, specifically, is to estimate the subject's level of fatigue. The fatigue level of a subject may be used to gauge that subject's ability to safely perform a task that may be susceptible to fatigue related errors and accidents (e.g. piloting a jet fighter).

It is generally desirable that the subject of a stimulus-response test maintain a high degree of focus and motivation throughout the duration of the test. If the testing subject is not operating at or near the best of his or her ability, the test results may not produce a reliable way to measure, assess, quantify, or manage fatigue. This is particularly true when the test involved is a reaction-time test. The testing subject's motivation, level of interest, overall boredom, and lack of focus can, at times, substantially interfere with test performance. There is a general desire to increase motivation to perform on stimulus-response tests and to safeguard compliance with the stimulus-response testing system protocols (e.g., staying within the rules of the test) by adding a competitive psychological element to the test when multiple testing subjects are available.

Stimulus-response tests (including reaction-time tests) may be delivered on a wide variety of hardware and software platforms. For example, stimulus-response tests may be administered on personal computers, which comprise relatively common stimulus output devices (e.g. monitors, displays, LED arrays, speakers and/or the like) and relatively common response input devices (e.g. keyboards, computer mice, joysticks, buttons and/or the like). As another example, stimulus-response tests can be administered by dedicated hardware devices with particular stimulus output devices and corresponding response input devices.

When comparing the results of stimulus-response tests administered on different hardware and/or software systems, one additional issue to address—particularly when the timing of a response relative to a stimulus event is of interest—is the latency between various components of the hardware and/or software systems. By way of non-limiting example, there may be latency associated with a computer implementing a stimulus-response test, latency of a response input device, latency of a stimulus output device, latency of the interfaces between the components of a system implementing a stimulus-response test, and/or the like, and such latencies may be different for different hardware and/or software systems. Furthermore, the latency of any given component may not be fixed or even well-known ab initio. See, e.g., U.S. patent application Ser. No. 12/777,107, (Publication No. 2010/0312508) Methods and Systems for Calibrating Stimulus-Response Testing Systems, the entirety of which is hereby incorporated by reference, for systems and methods to measure and address issues of latency in testing systems.

### SUMMARY

One aspect of the invention provides a method for scoring a stimulus-response test administered over a distributed computing environment. The method comprises: a) administering a stimulus-response test from a server computer to a plurality of test-takers via one or more client computers connected to the server computer over a communication network, wherein administering the stimulus-response test comprises, for each client computer, causing the client computer: to present a stimulus trigger; and to receive, from each test-taker taking the stimulus-response test at the client computer, an acknowledgement input responsive to the stimulus trigger; b) receiving a response time for each test-taker at the server computer, wherein, for each test-taker, the response time comprises a time difference between: the presentation of the stimulus trigger by the client computer at which the test-taker is taking the stimulus-response test; and the receipt of the acknowledgement input by the client computer at which the test-taker is taking the stimulus-response test; c) analyzing the response time for each test-taker, wherein analyzing the response time comprises applying a categorization rule to each response time, the categorization rule assigning one of a plurality of response types to each response time based on the response time falling within a corresponding one of a plurality of response-time ranges; d) determining a score for each test-taker at the server computer based at least in part on both the response time of the test-taker and the response type assigned to the response time of the test-taker by the categorization rule.

Another aspect of the invention provides a method for scoring a stimulus-response test administered over a distributed computing environment. The method comprises: a) administering a stimulus-response test from a server computer to a plurality of test-takers via one or more client computers connected to the server computer over a communication network, wherein administering the stimulus-response test comprises, for each client computer, causing the client computer: to present a stimulus trigger; and to receive, from each test-taker taking the stimulus-response test at the client computer, an acknowledgement input responsive to the stimulus trigger; b) receiving a response time for each test-taker at the server computer, wherein, for each test-taker, the response time comprises a time difference between: the presentation of the stimulus trigger by the client computer at which the test-taker is taking the stimulus-response test; and the receipt of the acknowledgement input by the client computer at which the test-taker is taking the stimulus-response test; c) receiving response latency correction data corresponding to each of test-takers at the server computer, the response latency correction data, for each test-taker, based on one or more of: characteristics of the client computer on which the test-taker is taking the stimulus-response test and neurobehavioral characteristics of the test-taker other than the response time; d) determining a score for each test-taker at the server computer based at least in part on both the response time of the test-taker and the response latency correction data corresponding to the test-taker.

Another aspect of the invention provides a method for scoring a stimulus-response test administered over a distributed computing environment. The method comprising: a) administering a stimulus-response test from a server computer to a plurality of test-takers via one or more client computers connected to the server computer over a communication network, wherein administering the stimulus-response test comprises administering a plurality of stimulus-response rounds and wherein administering each stimulus-response round comprises, for each client computer, causing the client computer: to present a corresponding stimulus trigger for the round; and to receive, from each test-taker taking the stimulus-response test at the client computer, an acknowledgement input for the round responsive to the stimulus trigger for the round; b) for each stimulus-response round, receiving a response time for the round for each test-taker at the server computer, wherein, for each test-taker, the response time for the round is based at least in part on a time difference between: the presentation of the stimulus trigger for the round by the client computer at which the test-taker is taking the stimulus-response test; and the receipt of the acknowledgement input for the round by the client computer at which the test-taker is taking the round of the stimulus-response test; c) determining a composite score for each test-taker at the server computer by applying a composite score metric to the response times of the test-taker for at least two stimulus-response rounds.

Further aspects and embodiments of the invention are disclosed in the following detailed description and the appended drawings.

### BRIEF DESCRIPTION OF THE DRAWINGS

In drawings that depict non-limiting embodiments of the invention:

FIG. 1 is a schematic block diagram representation of a prior-art stimulus-response test delivery system;

FIG. 2 provides a flowchart that describes a set of methods for scoring competitive stimulus-response tests according to several embodiments;

FIG. 3A provides a timeline illustrating the analysis of response times into response types, sub-types, and sub-sub-types according to a classification rule, in accordance with a particular embodiment;

FIG. 3B provides a flowchart illustrating a non-limiting example process for applying the classification rule of FIG. 3A;

FIG. 4 is a schematic diagram of a system for administering a multi-subject stimulus-response test from a single testing apparatus; and

FIG. 5 is a schematic diagram of a system for administering a multi-subject stimulus-response test over several testing apparatus linked by a communications network.

FIG. 6 is a set of histograms showing results of a two-person stimulus-response test; and

FIG. 7 is a set of tables showing the results of a two-person stimulus-response test as scored by several composite score metrics.

### DETAILED DESCRIPTION

Throughout the following description, specific details are set forth in order to provide a more thorough understanding of the invention. However, the invention may be practiced without these particulars. In other instances, well-known elements have not been shown or described in detail to avoid unnecessarily obscuring the invention. Accordingly, the specification and drawings are to be regarded in an illustrative, rather than a restrictive, sense.

The terms “fatigue level” and “fatigue state” are used interchangeably throughout the following discussion to refer to an overall level of fatigue of one or more individuals. It is understood that fatigue is inversely related to alertness. That is, when the fatigue level of an individual is higher, his or her alertness level is lower and vice versa. Consequently, the terms alertness level and alertness state may also be used interchangeably with fatigue level and/or fatigue state. Other types of neurobehavioral performance such as “sleepiness”, “tiredness”, “cognitive performance”, and/or “cognitive throughput” may be conceptually distinguished from “fatigue” in some contexts. As used herein, however, the terms “fatigue level” and “fatigue state” should be understood in the broader sense to include indicators of these types of neurobehavioral performance as well.

An administrator of the stimulus-response test scoring system and methods described herein may be referred to as a “user” or “system user.” In some cases a user may also be a subject. In some cases, a user may be an organization (or a plurality of members of an organization) rather than a specific person.

Stimulus-response tests involve providing stimulus to a subject (e.g. a human or other animal subject) and observing the resultant response. Observed responses may then be further analyzed. Analysis of results from stimulus-response tests may include generating metrics indicative of the type of response (e.g. for a given stimulus event) and/or the timing of the response (e.g. relative to the timing of a stimulus event). It will be appreciated that for stimulus-response tests, where the timing of the response relative to the stimulus is considered to be important, measurement of the timing of stimulus and response events may be of commensurate importance. Stimulus-response tests may be instantiated in numerous varieties that differ by the particular methods for providing stimuli to a subject, assessing or recording a time at which the stimuli are presented, and assessing or recording a time at which the subject responds to the stimulus. Increased motivation for testing subjects may be found through the use of competitive scoring techniques that oppose one testing subject against another. Such techniques include comparing mean reaction times among different subjects, displaying one subject's score on another subject's display device, and/or the like.

Stimulus-response tests include a variety of tests which are designed to evaluate, among other things, aspects of neurobehavioral performance. Non-limiting examples of stimulus-response tests that measure or test an individual's alertness or fatigue include: i) the Psychomotor Vigilance Task (PVT) or variations thereof (Dinges, D. F. and Powell, J. W. “Microcomputer analyses of performance on a portable, simple visual RT task during sustained operations.” Behavior Research Methods, Instruments, & Computers 17(6): 652-655, 1985); ii) the Digit Symbol Substitution Test; and iii) the Stroop test. All of the publications referred to in this paragraph are hereby incorporated by reference herein.

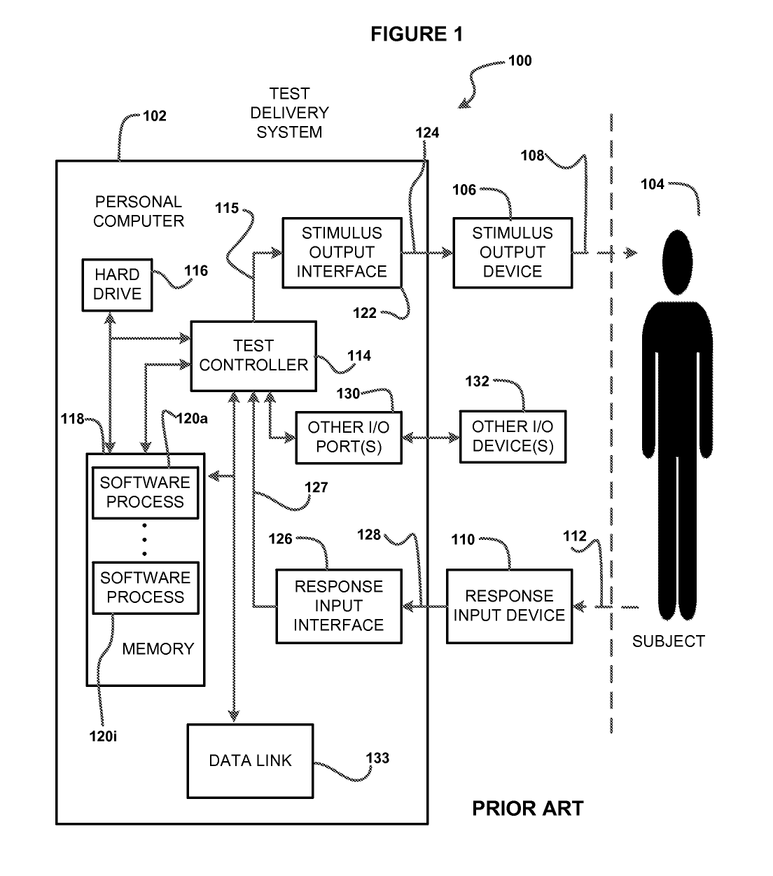

Various testing systems and apparatus are available that measure and/or record one or more characteristics of a subject's responses to stimuli. Such testing systems may be referred to herein as “stimulus-response test systems,” “stimulus-response apparatus,” and/or “stimulus-response tests.” In some embodiments, such stimulus-response systems may also generate the stimuli. By way of non-limiting example, the types of response characteristics which may be measured and/or recorded by stimulus-response test systems include the timing of a response (e.g. relative to the timing of a stimulus), the intensity of the response, the accuracy of a response and/or the like. While there may be many variations of such stimulus-response test systems, for illustrative purposes, this description considers the FIG. 1 test system 100 and assumes that stimulus-response test system 100 is being used to administer a psychomotor vigilance task (PVT) test. Stimulus-response test system 100 comprises controller 114 which outputs a suitable signal 115 which causes stimulus output interface 122 to output signal 124 and stimulus output device 106 to output a corresponding stimulus 108. Stimulus 108, which is output by stimulus output device 106, may include a stimulus event. When subject 104 perceives a stimulus event to be of the type for which a response is desired, subject 104 responds 112 using response input device 110. Response input device 110 generates a corresponding response signal 128 at response input interface 126 which is then directed to controller 114 as test-system response signal 127.

Test controller 114 may measure and/or record various properties of the stimulus response sequence. Such properties may include estimates of the times at which a stimulus event occurred within stimulus 108 and a response 112 was received by test system 100. The time between these two events may be indicative of the time that it took subject 104 to respond to a particular stimulus event. In the absence of calibration information, the estimated times associated with these events may be based on the times at which controller 114 outputs signal 115 for stimulus output interface 122 and at which controller 114 receives test-system response signal 127 from response input interface 126.

However, because of latencies associated with test system 100, the times at which controller 114 outputs signal 115 for stimulus output interface 122 and at which controller 114 receives test-system response signal 127 from response input interface 126 will not be the same as the times at which a stimulus event occurred within stimulus 108 and a response 112 was received by test system 100. More particularly, the time between controller 114 outputting signal 115 for stimulus output interface 122 and receiving test-system response signal 127 from response input interface 126 may be described as tₜₒₜ where tₜₒₜ=tₛₜᵢₘₗᵣₑₛₚ+tₗₐₜ, where tₛₜᵢₘₗᵣₑₛₚ represents the time of the actual response of subject 104 (i.e. the difference between the times at which a stimulus event occurred within stimulus 108 and a response 112 was received) and where tₗₐₜ represents a latency parameter associated with test system 100. Latencies may be caused by delays in electrical signal transmission between a response input interface 126 and test controller 114, software polling delays in the test controller 114, keyboard hardware sampling frequency in a response input device 110, and the like. The latency parameter tₗₐₜ may comprise, for example, a combination of the latency between the recorded time of the output of signal 115 by controller 114 and the time that a stimulus event is actually output as a part of stimulus 108, the latency between the time that response 112 is generated by subject 104 and the time that test-system response signal 127 is recorded by controller 114 and/or other latencies.

Stimulus-response test system 100 may also include a data communications link 133. Such data communications link 133 may be a wired link (e.g. an Ethernet link and/or modem) or a wireless link. Stimulus-response test system 100 may include other features and/or components not expressly shown in the FIG. 1 schematic drawing. By way of non-limiting example, such features and/or components may include features and/or components common to personal computers, such as computer 102.

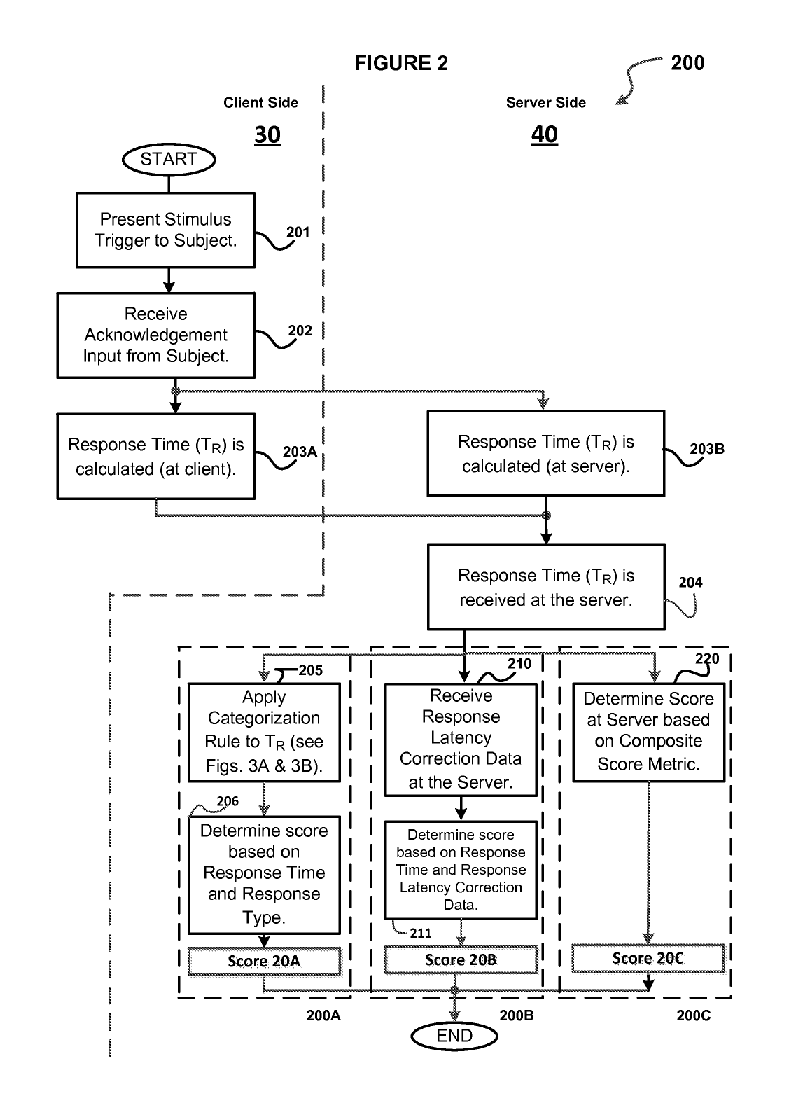

FIG. 2 illustrates several related methods, collectively referred to as method 200 and separately as methods 200A, 200B, 200C, for competitively scoring stimulus-response tests in accordance with different embodiments of the invention. Methods 200A, 200B, and 200C share steps 201 through 204 in common, but differ thereafter. Method 200A proceeds with steps 205 and 206; method 200B proceeds with steps 210 and 211; and method 200C proceeds with step 220, all as indicated in FIG. 2.

Method 200 provides a method for competitively scoring a stimulus response test. Method 200 commences in step 201 where a stimulus trigger 108 is presented to testing subject 104 at a client computer 30. Non-limiting examples of the stimulus trigger 108 include a visual display on a display screen, an audible tone, a vibration, and/or the like.

Method 200 continues in step 202, in which an acknowledgement input 112 is received from testing subject 104 at the client computer 30. Non-limiting examples of acknowledgement input 112 include a press of a key or button, a body movement, speaking a sound, clicking a mouse, touching a screen, and/or the like. A response time T_{R} must then be calculated and, in step 204, eventually received at the server computer 40. The response time T_{R} consists of the time difference between the presentation of the stimulus trigger 108 by the client computer 30 in step 201 and the receipt of the acknowledgement input 112 by the client computer 40 in step 202.

In particular embodiments, response time T_{R} is calculated at the client computer 30 in step 203A. In some embodiments, the response time T_{R} may additionally or alternatively be calculated at the server computer 40 in step 203B. A non-limiting example of calculating response time T_{R} at the client computer 30 in step 203A comprises recording the time that the client computer 30 sends a visual display signal to a monitor (the stimulus trigger 108) by reading the time stamp of a clock embedded in the client computer 30, then recording the time at which the client computer 30 receives a keyboard input (an acknowledgement input 112) by reading the time stamp of the clock embedded in the client computer 30, and then the client computer 30 determining the difference between the two time stamps. A non-limiting example of calculating response time T_{R} at the server computer 40 in step 203B comprises the server computer 40 receiving over a network, a UMT (Universal Metric Time) timestamp of the time at which a stimulus trigger 108 was presented to a user on a client computer 30, then the server receiving over a network a UMT timestamp of the time at which an acknowledgement input 112 was received by a client computer 30, and then the server computer 40 determining the difference between the two time stamps. Ultimately the response time T_{R} is received at the server computer in block 204.

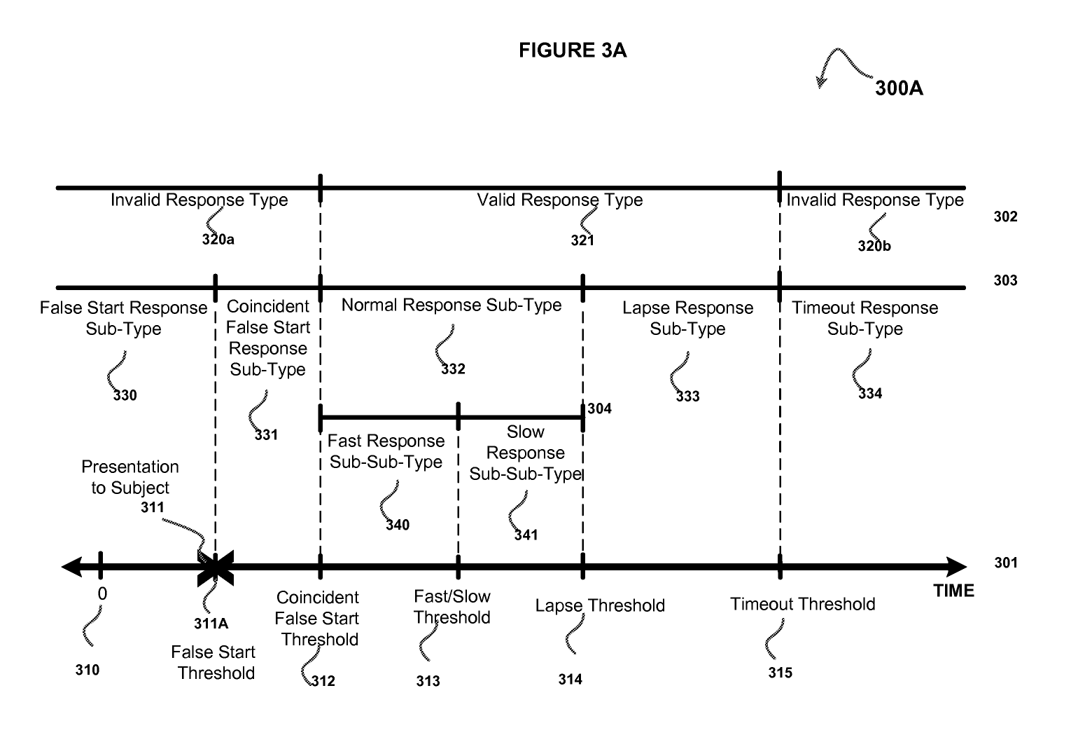

In embodiments of method 200 which incorporate method 200A, the method then proceeds to step 205 by applying a categorization rule 300A to response time T_{R} at the server computer 40. Categorization rule 300A assigns one or more response types to the response time T_{R} received at the server computer 40 in step 204. Non-limiting examples of response types (including response sub-types, and response sub-sub types, according to alternate embodiments) include valid responses, invalid responses, false starts, coincident false starts, fast responses, slow responses, lapses, timeouts, button-stuck responses, and/or the like. In particular embodiments, where the stimulus-response test is the PVT several response types are illustrated in connection with the categorization rule 300A of FIG. 3.

Method 200A then concludes in step 206 which involves determining a score 20A for response time T_{R} based at least in part on the response time T_{R} itself and the response type. Non-limiting examples of determining scores 20A in step 206 include: assigning a numerical value based on the categorization of the response time where, e.g., the value=1 if the category is valid, the value=−1 if the category is false start, and value=−2 if the category is lapse; assigning a value proportional to the response time if the response is valid (e.g. value=200 if the response time is 200 ms and the category is valid), and assigning a fixed value if the response type is invalid (e.g. value=1000 if the category is false start); and/or the like.

Method 200B provides another method for scoring a stimulus-response test in accordance with another exemplary embodiment of the present invention. In embodiments of method 200 which incorporate method 200B, the method proceeds from step 204 to step 210, wherein response latency correction data 605 is received at the server computer 40. Response latency correction data 605 of step 210 may include any collection of data received at the server 40 sufficient to determine the latency parameter tₗₐₜ associated with stimulus-response system 100. Response latency correction data 605 may be determined by a calibration system. A non-limiting example of a calibration system can be found in U.S. Patent Application Publication 2010/0312508, referred to above.

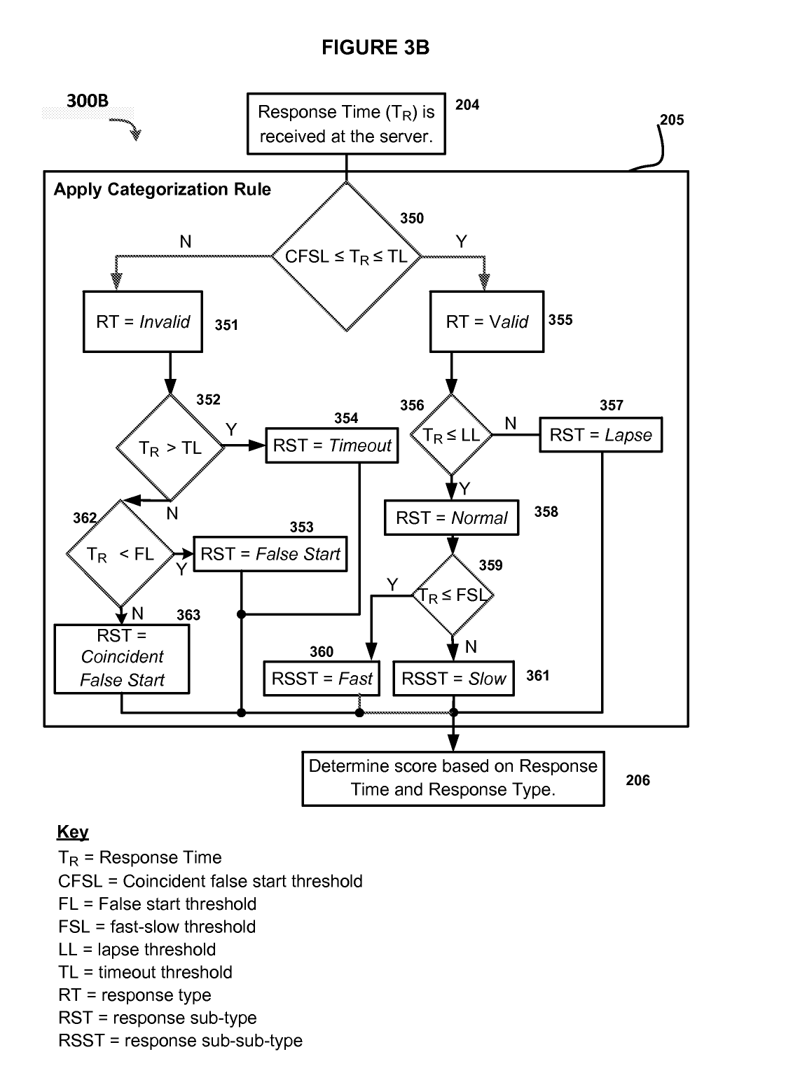

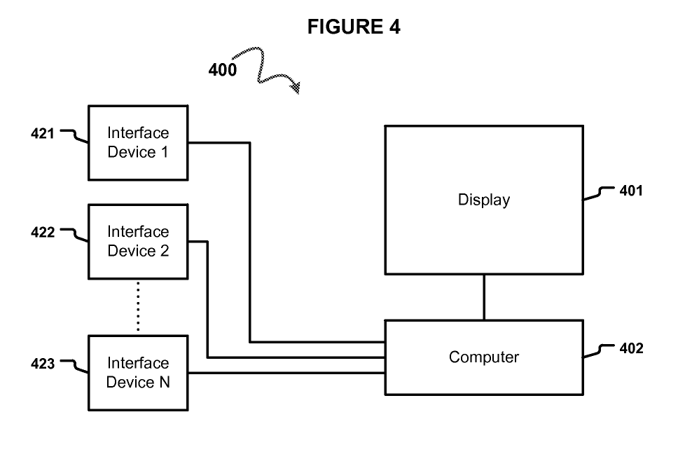

Test scores 20B may then be determined in step 211 based upon the response time T_{R} and the response latency correction data 605. By way of non-limiting example, score(s) 20B may be determined by using response latency correction data 605 to determine the latency parameter tₗₐₜ and then applying the latency parameter tₗₐₜ as an offset from response time 15. In a multi-unit test system (e.g., FIGS. 4 and 5) if testing system A is a fast computer and has a latency parameter tₗₐₜ of 25 ms, and system B is a slow computer with a latency parameter tₗₐₜ of 55 ms, block 211 may involve determining scores by subtracting 25 ms from the block-204 response times received from system A and subtracting 55 ms from the block-204 response times received from system B.

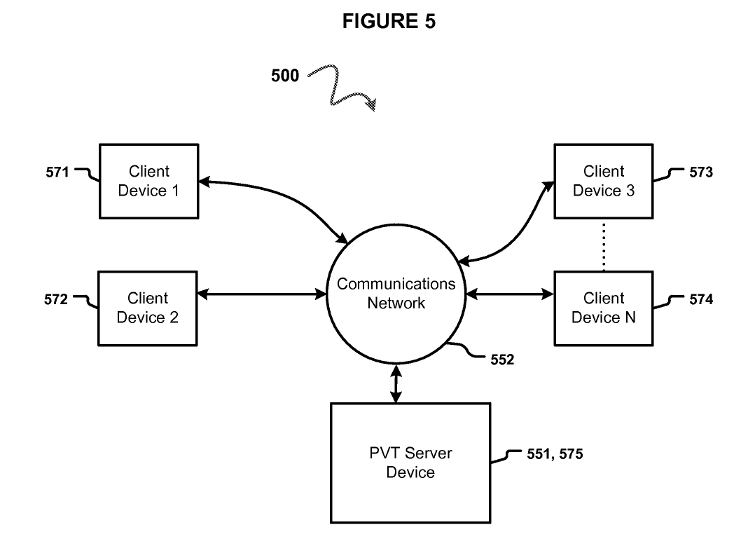

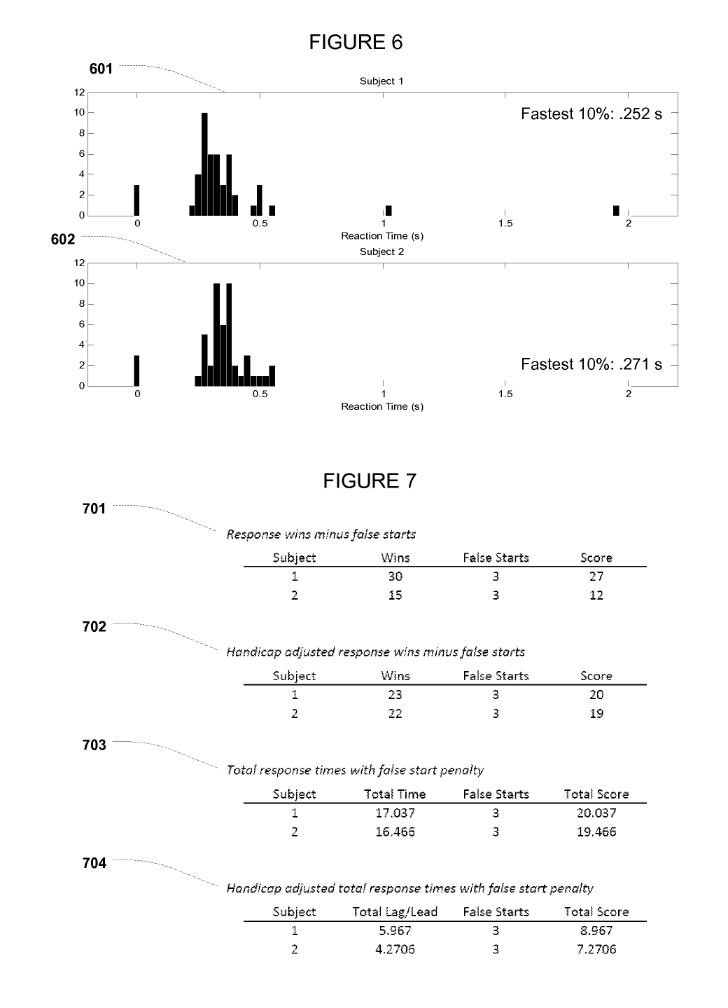

Method 200C provides another method for scoring a stimulus-response test in accordance with an exemplary embodiment of the present invention. In embodiments of method 200 which incorporate method 200C, the method proceeds from 204 to step 220, which involves applying a composite score metric 705 at the server computer 40 to determine a score 20C. Non-limiting examples of composite score metric 705 include: ranking each testing subject's response time T_{R} based upon the order in which the response time T_{R} is received at the server 40; assigning points to each response time T_{R} based upon the rank thus assigned; assigning points but then subtracting a number of points equal to the rank (i.e., index of the order in which the response time is received at the server) based upon the number of testing subjects 104 competing simultaneously; deducting a number of points from a subject's points total for response time T_{R} being categorized in a particular way (e.g., false starts, timeouts, lapses, etc.); determining the subject's fastest potential reaction time and deducting it from the response time T_{R}; centering the mean of each subject's fastest potential reaction time (i.e., adjusting each subject's set of received reaction times such that all subjects have the same mean reaction time); weighting each response time T_{R} according to its order in the stimulus-response sequence (i.e., whether it occurs early or late in the test); applying a weighting function to a complete set of response times; calculating a weighted average of all response times T_{R} for the subject; and/or the like. Step-220 composite score metrics are discussed more fully below in connection with FIGS. 6 and 7.

FIG. 3A is a timeline representation of an exemplary categorization rule 300A used to assign response types to response times T_{R}. Categorization rule 300A of FIG. 3A may be used to implement step 205 of method 200A (FIG. 2). Categorization rule 300A is provided in the form of a timeline 301 indicating different response types 302, response sub-types 303, and response sub-sub-types 304 for different response times 15. Timeline 301 is provided with a zero point 310, from which response times T_{R} may be categorized—i.e., response times on the FIG. 3A timeline may be measured as starting from zero point 310. Zero point 310 may represent the time at which output signal 124 corresponding to a stimulus event is sent to stimulus-output device 106 (FIG. 1). Presentation indicator 311 (displayed as an “X”) is situated on timeline 301 at the time at which stimulus 108 is presented to the subject 104. The time difference between zero point 310 and presentation indicator 311 comprises, in non-limiting embodiments, the response latency parameter tₗₐₜ.

Vertical indicators across timeline 301 are provided to indicate a false start threshold 311A, coincident false start threshold 312, a fast-slow response threshold 313, a lapse threshold 314, and a timeout threshold 315. In particular embodiments the false start threshold 311A is set at 0 ms (i.e., any response signal 128 that comes before the presentation of the stimulus event), the coincident false start threshold 312 is set at 120 ms, fast-slow response threshold 313 is set at 250 ms, lapse threshold 314 is set at 500 ms, and timeout threshold 315 is set at 10,000 ms (i.e., 10 seconds). In alternative embodiments one or more of thresholds 312, 313, 314, 315 may be user configurable.

In a particular embodiment categorization rule 300A operates by assigning a response type 302, and optionally a response sub-type 303 and optionally a response sub-sub-type 304, depending upon the relationship between the step-204 received response time T_{R} and one or more of thresholds 311A, 312, 313, 314, 315. Each of the regions between (and on either side of) thresholds 311A, 312, 313, 314, 315 is provided with a name, and categorization rule 300A assigns response time T_{R} with a response type 302 in accordance with the region in which response time T_{R} lies.

For example, a valid response type region 321 is illustrated as lying between the coincident false start threshold 312 and the timeout threshold 315. Response times T_{R} between these two thresholds are assigned a “valid” response type. An invalid response type region 320 is divided among two regions: the time region 320A before coincident false start threshold 312, and the time region 320B after timeout threshold 315. Response times shorter than the coincident false start threshold 312 or longer than the timeout threshold 315 are assigned an “invalid” response type.

In particular embodiments, response times that equal the threshold 311A, 312, 313, 314, 315 values are considered to lie within the region to the left of the threshold 311A, 312, 313, 314, 315. In other embodiments, response times that equal the threshold 311A, 312, 313, 314, 315 values are considered to lie within the region to the right of the threshold 311A, 312, 313, 314, 315.

Categorization rule 300A may optionally assign response sub-types in a similar fashion. In the illustrated embodiment, valid response type region 321 is further divided into a normal response sub-type region 332 and a lapse response sub-type region 333. Normal response sub-type region 332 lies between coincident false start threshold 312 and lapse threshold 314. A response time falling in the normal response sub-type region 332 indicates that subject 104 has responded as expected to the stimulus event. Lapse response sub-type region 333 lies between lapse threshold 314 and timeout threshold 315. A response time falling in the lapse sub-type region 333 indicates that subject 104 may have responded to the stimulus event in a valid manner, but the response time is sufficiently slow as to indicate the presence of one or more testing-relevant occurrences—e.g., the subject 104 may have been distracted, may not have been paying close attention, may have been suffering from fatigue, and/or the like.

In the illustrated embodiment, invalid response type region 320, comprising regions 320A and 320B, is further divided into a timeout response sub-type region 334 (comprising the entirety of region 320B after the timeout threshold 315), along with a false-start response sub-type region 330 (prior to false-start threshold 311A) and a coincident false-start sub-type region 331 (between false-start threshold 311A and coincident false start threshold 312). Timeout response sub-type region 334 comprises all times longer than the timeout threshold 315. A response time falling within the timeout response sub-type region 334 may indicate that the testing subject 104 has abandoned the test, may have been significantly distracted, may have fallen asleep, and/or the like; or it may indicate a malfunction with the stimulus-response testing system 100. False start response sub-type region 330 comprises all times greater than the time zero indicator 310 but shorter than the time at which the stimulus trigger 108 is presented to the testing subject 104 (as indicated by the position of presentation indicator 311).

In some embodiments, response sub-types may be further divided into response sub-sub-types 304. In the illustrated embodiment of FIG. 3A, for example, the normal response sub-type range 332 is divided into a fast response sub-sub-type range 340 and a slow response sub-sub-type range 341. Response times T_{R} classified as “fast” by classification rule indicate responses from the testing subject that are among the shortest times within the normal range, whereas response times classified as “slow” are still within the normal range but tend to be a bit longer. Fast/slow response threshold 313 marks the dividing line between fast response sub-sub-type range 340 and slow response sub-sub-type range 341.

FIG. 3B is a flowchart representation of a method 300B for implementing categorization rule 300A (FIG. 3A). Method 300B may be used to implement step 205 of method 200A (FIG. 2). Method 300B commences with step 350, in which response time T_{R} is compared to the coincident false start threshold (CFSL) 312 and the timeout threshold (TL) 315 (see FIG. 3A). If response time (T_{R}) lies between the two thresholds 312, 315, the step-350 inquiry is positive and method 300B proceeds to step 355, where the response type is categorized as valid. If not, then the step-350 inquiry is negative and method 300B proceeds to step 351, wherein the response type is categorized as invalid. Proceeding with the “invalid” response-type branch of method 300B, step 352 compares response time RT to the coincident false start threshold 312 and proceeds to step 353 if response time RT is less then threshold 312, wherein the response sub-type is categorized as a “false start,” and proceeds to step 354 if response time is greater than coincident false start threshold 315, wherein the response sub-type is categorized as a “timeout.”

For the “valid” response-type branch of method 300B, step 356 compares response time R_{T} to the lapse threshold (LL) 314 and categorizes, in step 357, the response sub type as “lapse” if response time R_{T} is greater than threshold (LL) 314, and categorizes, in step 358, the response sub-type as “normal” if response time RT is greater than threshold (LL) 314. Step 359 compares response time R_{T} RT to the fast-slow threshold (FSL) 313. The response sub-sub type is then categorized, in step 360, as “fast” if the response time R_{T} is less than fast-slow threshold (FSL) 313 or, in step 361, as “slow” otherwise.

FIG. 4 illustrates how a multi-subject PVT can be administered by a single system 400 with a plurality of interface devices. System 400 may contain a computer 402, a display 401, and any number of suitable interface devices 421, 422, 423, where each interface device 421, 422, 423 includes an output device (not shown) for providing the stimulus and an input device (not shown) for receiving a response. Non-limiting examples of output devices include a speaker, a tactile feedback device, a display screen, a tactile feedback device, and/or any other device that can be detected by any one of the human senses. One interface device might be configured to receive responses from more than one subject, such as is the case if the interface device comprises an I/O controller configured to manage input from multiple sources. In such embodiments, the client-side steps of method 200 (steps 201, 202, and 203A) may be executed on the interface devices 421, 422, 423 or on the computer 402. Server-side steps of method 200 (steps 203B, 204-206, 210, 211, and 220) may be practiced on the computer 402. Alternatively, server-side steps of method 200 (steps 203B, 204-206, 210, 211, and 220) may be practiced on another computer system (not shown) connected to computer 402.

A multi-device controller, however, is not the only way in which multiple inputs can be received from a single interface device. Other non-limiting examples of how interface devices could be made to receive multiple inputs include: a touch-screen of the interface device, which might optionally be partitioned into more than one section and where each section may optionally be assigned to receive input from a different subject; a keyboard of the interface device, which may optionally permit different subjects to respond by pressing different keys; and/or the like. Additionally, an interface device may contain a screen which could display information about the test, such as the current score, or which may even be used to display the stimulus.

Referring to FIG. 5, a multi-subject PVT might also be administered over a communications network 552. One device acts as a PVT server 551. A plurality of client devices 571, 572, 573, 574 maintains contact with the server using the communications network 552. In some implementations, PVT server 551 may also serve a dual purpose as a client device 575. Also, a client device may be associated with more than one subject and may receive input from each. (This is so because each client device 571, 572, 573, 574 may comprise a computer with a plurality of interface devices, as shown in FIG. 4, each capable of managing input and output for multiple testing subjects.) The communication protocol between server and client can be standardized so that the client devices 571, 572, 573, 574 need not be the same physical device nor run the same software. A client device need not necessarily have a display if the state of the PVT and a stimulus can be presented to a subject in another way, such as through sound. A dedicated PVT server device 551 could also serve as a storage repository for the neurobiological and cognitive performance measurement data and scoring data collected by the PVT. Where scoring data is kept by a centralized, dedicated server 551, server 551 could provide a “leader board” or some other suitable score aggregation to be generated for the subjects using the PVT server 551. Cognitive performance data may additionally or alternatively be stored on a client device 571, 572, 573, 574 with server 557 acting strictly as a system to create or to enhance the competitive environment. In some implementations, cognitive performance data may be placed into long-term storage on either or both of client devices 571, 572, 573, 574 or server device 557.

Reporting the output from the presently disclosed systems and methods can take a variety of forms. In some cases, only data related to a specific testing subject is desired, whereas for other situations a comparison among two or more subjects is desired. Furthermore, different data can be displayed for the one or more subjects involved—ranging from a list of reaction times and reaction types (e.g., valid, false start, timeout etc.), to some computed result derived from the reaction times (e.g., average, mean, standard variation, top 10%, etc.), to a comparison of result data to that of a larger population (e.g., percentile ranking as compared to other similar employees, etc.) to various scoring or classification schema (e.g., a fixed score on a 100 point scale, classification of responses as “Good,” “Bad,” “Average,” etc.). The output varieties reflected in the discussion that follows are meant as illustrations only, and do not exhaust the many ways in which the presently disclosed systems and methods can be configured to generate useful output.

FIG. 6 provides an exemplary histogram of the reaction-time results from a two-subject competitive PVT according to an embodiment of method 200C (FIG. 2). The top graph 601 of FIG. 6 shows the results for a first testing subject (“Subject 1”), and the bottom graph 602 of FIG. 6shows the results for a second testing subject (“Subject 2”). Reaction times of zero correspond to false starts. The FIG. 6 histograms show that Subject 2 was vigilant throughout the test, whereas Subject 1 committed two overly long responses (e.g., lapses), at roughly 1.1 and 1.9 seconds, respectively. The FIG. 6 data shows that Subject 1 experienced significant fatigue or may have become resigned. When scored differently, however, the FIG. 6 graphs show different results, for example by comparing the mean of the fastest ten percent of the responses for each subject, on the other hand, it appears that Subject 1 has a slightly faster nervous system than Subject 2.

FIG. 7 shows a number of different exemplary composite score metrics that may be used on the PVT data presented in FIG. 6 in accordance with step 200 of method 200C (FIG. 2). A step-220 composite score metric is any function, rule of categorization, classification system, scoring system, and/or the like that can be applied to two or more response times of at least one testing subject to determine a single score value for each testing subject to which the composite score metric is applied. Non-limiting examples of step-220 composite score metrics include at least the following: i) for every stimulus event, two or more subjects could be ranked based upon the order in which the respond; ii) for each stimulus event, points could be awarded to two or more subjects based on their rankings; iii) points could be calculated by subtracting each subject's ranking from the total number of subjects; iv) a number of points can be deducted for certain undesirable response types (e.g., false starts, coincident false starts, lapses, timeouts, and/or like); v) a series of response times of a given subject could be analyzed for the subject's fastest potential reaction time; vi) the mean response time for one or more testing subjects could be centered with respect to one another (i.e., response times for each subject are adjusted such that all subjects have the same mean response time); and/or the like. Any of the foregoing step-220 composite score metrics could be used in combination with one another or with any other scoring method disclosed herein.

Specifically, chart 701 of FIG. 7 presents the results of applying a particular exemplary step-220 composite score metric to the data supplied in connection with FIG. 6. Subject 1 responded faster on thirty (30) of the forty-five (45) stimulus events and Subject 1 and Subject 2 each committed three (3) false starts. The score column of chart 701 shows the scores of Subject 1 and Subject 2 using an example composite scoring metric wherein a point is awarded for each stimulus-response round won, but with a penalty for false starts equal to the number of testing subjects minus one. According to this composite scoring metric, Subject 1 beats Subject 2 with a score of 27 to 12

Other exemplary composite score metrics take into account each subject's fastest potential reaction time. A non-limiting example occurs where one testing subject has a fastest potential reaction time of 180 ms and a second testing subject has a fastest potential reaction time of 200 ms. For a given stimulus event, the first subject may respond after 210 ms and the second subject may respond after 220 ms. In a situation where only reaction time is considered, the first subject would be ranked first, since she has a lower reaction time. If, however, the difference between reaction time and fastest potential reaction time is considered, the first subject was 30 ms behind her potential, and the second person was 20 ms behind his potential. Thus, in a system where fastest potential reaction time is considered, the second subject may be scored as the winner of the round.

Chart 702 of FIG. 7 shows the results of applying a composite score metric to the data depicted in FIG. 6 according to an embodiment utilizing fastest potential reaction time. The fastest potential reaction time for each subject may be approximated by the mean of the fastest ten percent of that subject's recorded reaction times. In the exemplary case of chart 702, Subject 1 still scores higher than does Subject 2 by a very slight margin. The winner for each round was determined by a step-220 composite scoring metric that comprises subtracting the approximation of each subject's fastest potential reaction time from that subject's actual reaction time for the round and comparing the results. The subject with the lowest number was scored as the winner of the round. Since both Subject 1 and Subject 2 have the same number of false starts, Subject 1 would be declared the winner by a score of 20 to 19.

Chart 703 of FIG. 7 shows a composite score metric that involves a sum of all of the subject's valid response times plus a one-second penalty for each false start. Chart 703 shows that Subject 2 has a lower sum of reaction times than does Subject 1. Since each subject has the same number of false starts, Subject 2 would be declared the winner under this scoring system, which is a different result from the scoring methods shown in charts 701 and 702. Chart 704 of FIG. 7 shows a scoring method similar to that of chart 703 involving a composite score metric, except that the scoring system is adjusted for fastest potential reaction time by summing the lag or lead behind a subject's fastest potential reaction time. That is, the fastest potential reaction time for each subject is deducted from each recorded reaction time for that subject. Because the advantage in fastest potential reaction time that Subject 1 had over Subject 2 is removed, the results tilt more decidedly in favor of Subject 2.

Composite scoring methods are not limited to those shown in FIG. 7. Another possible step-220 composite score metric involves centering the mean response times for two or more testing subjects. Centering the mean response time may comprise finding, on a subject-by-subject basis, the mean response time for all responses received at the server for each testing subject. The mean value for a given subject's response times is then subtracted from all of the testing subject's response times. This step is repeated for all testing subjects, thereby centering the mean reaction time for all subjects at zero.

As another example scoring system, subjects may be ranked at the end of the PVT based on the sum of their reaction times. Thus, if a subject is generally quite fast to react, but several times had a very long lag between stimulus and reaction, he might still lose even though he was the fastest to respond in a majority of events.

Certain implementations of the invention comprise computer processors which execute software instructions which cause the processors to perform a method of the invention. For example, one or more processors may implement data processing steps in the methods described herein by executing software instructions retrieved from a program memory accessible to the processors. The invention may also be provided in the form of a program product. The program product may comprise any medium which carries a set of computer-readable instructions which, when executed by a data processor, cause the data processor to execute a method of the invention. Program products according to the invention may be in any of a wide variety of forms. The program product may comprise, for example, physical media such as magnetic data storage media including floppy diskettes, hard disk drives, optical data storage media including CD ROMs and DVDs, electronic data storage media including ROMs, flash RAM, or the like. The instructions may be present on the program product in encrypted and/or compressed formats.

Certain implementations of the invention may comprise transmission of information across networks, and distributed computational elements which perform one or more methods of the inventions. For example, response times may be delivered over a network, such as a local-area-network, wide-area-network, or the internet, to a different computational device that scores the response times. Such a system may enable a distributed team of operational planners and monitored individuals to utilize the information provided by the invention. Such a system would advantageously minimize the need for local computational devices.

Certain implementations of the invention may comprise exclusive access to the information by the individual subjects. Other implementations may comprise shared information between the subject's employer, commander, flight surgeon, scheduler, or other supervisor or associate, by government, industry, private organization, etc., or any other individual given permitted access.

Certain implementations of the invention may comprise the disclosed systems and methods incorporated as part of a larger system to support rostering, monitoring, diagnosis, epidemiological analysis, selecting or otherwise influencing individuals and/or their environments. Information may be transmitted to human users or to other computer-based systems.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e. that is functionally equivalent), including components which are not structurally equivalent to the disclosed structure which performs the function in the illustrated exemplary embodiments of the invention.

It will be apparent to those skilled in the art in the light of the foregoing disclosure, many alterations and modifications are possible in the practice of this invention without departing from the spirit or scope thereof. For example:
The term “result” or “test result” are used in this application to apply generally to any output of a test, whether referring to a specific user response to a question or stimulus, or whether referring to a statistical analysis or other cumulative processing of a plurality of such user responses. In the case of stimulus-response tests, these terms may refer to the time intervals associated with specific responses to stimuli or to a cumulative metric of such time intervals collected in response to a plurality of stimuli presented throughout a test or portion thereof
Purely analytical examples or algebraic solutions should be understood to be included.
   Accordingly it is intended that the appended claims and any claims hereafter introduced are interpreted to include all such modifications, permutations, additions, and sub-combinations as are within their broadest possible interpretation.

What is claimed is:

1. A method for scoring a stimulus-response test administered over a distributed computing environment, the method comprising:
[a] administering a stimulus-response test from a server computer to a plurality of test-takers via one or more client computers connected to the server computer over a communication network, wherein administering the stimulus-response test comprises, for each client computer, causing the client computer: to present a stimulus trigger; and to receive, from each test-taker taking the stimulus-response test at the client computer, an acknowledgement input responsive to the stimulus trigger;
[b] receiving a response time for each test-taker at the server computer, wherein, for each test-taker, the response time comprises a time difference between: the presentation of the stimulus trigger by the client computer at which the test-taker is taking the stimulus-response test; and the receipt of the acknowledgement input by the client computer at which the test-taker is taking the stimulus-response test;
[c] analyzing the response time for each test-taker, wherein analyzing the response time comprises applying a categorization rule to each response time, the categorization rule assigning one of a plurality of response types to each response time based on the response time falling within a corresponding one of a plurality of response-time ranges;
[d] determining a score for each test-taker at the server computer based at least in part on both the response time of the test-taker and the response type assigned to the response time of the test-taker by the categorization rule.

2. A method according to claim 1 wherein applying the categorization rule to each response time comprises assigning a valid response type to the response time if the response time falls in a first time range and assigning an invalid response type to the response time if the response time falls in a second time range.

3. A method according to claim 2 wherein determining the score comprises, for each test taker:
determining a baseline response time for the test-taker, the baseline response time being indicative of a response-time characteristic of the test-taker;
calculating a baseline-adjusted response time by subtracting the baseline response time from the response time; and
determining the score based at least in part on the baseline-adjusted response time and the response type.

4. A method according to claim 3 wherein determining a baseline response time for the test-taker comprises receiving a baseline response time from one or more of: a user, a test-taker, a database, a client computer, a server computer, or a computer network.

5. A method according to claim 3 wherein determining a baseline response time for the test-taker comprises:
repeating, for one or more stimulus-response rounds of the test, the steps of:
[b] receiving a response time for each test-taker, and
[c] analyzing the response time for each test-taker;
identifying a subset of the analyzed response times having a corresponding valid response type;
determining the mean value of all response times within the identified subset; and
assigning the mean value thus determined to the baseline response time.

6. A method according to claim 5 wherein the identified subset of received response times comprises all received response times having a valid response type.

7. A method according to claim 5 wherein the identified subset of analyzed response times comprises all received response times with durations shorter than a baseline-response selection threshold.

8. A method according to claim 7 wherein the baseline-response selection threshold comprises the top-ten percent of shortest response times.

9. A method according to claim 2 wherein assigning the invalid response type to the response time comprises one or more of:
assigning a false start response sub-type to the response time if:
the response time falls in a false-start sub-range of the second time range, the false-start sub-range including times where the receipt of the acknowledgement input by the client computer occurs before the presentation of the stimulus trigger by the client computer;
assigning a coincident false start response sub-type to the response time if:
the response time falls in a coincident-false-start sub-range of the second time range, the coincident-false-start sub-range including times where the receipt of the acknowledgement input by the client computer occurs after the presentation of the stimulus trigger by the client computer, but prior to a coincident-false-start threshold;
and
assigning a timeout response sub-type to the response time if:
the response time falls in a timeout sub-range of the second time range, the timeout sub-range including times where the response time is positive and greater than a timeout threshold, the timeout threshold greater than the coincident-false-start threshold.

10. A method according to claim 2 wherein assigning the valid response type to the response time comprises:
assigning a normal response sub-type to the response time if:
the response time falls in a normal-response sub-range of the first time range, the normal-response sub-range including times where the receipt of the acknowledgement input by the client computer occurs after a coincident false start threshold but before a lapse threshold; and
assigning a lapse-response sub-type to the response time if:
the response time falls in a lapse-response sub-range of the first time range, the lapse-response sub-range including times where the receipt of the acknowledgement input by the client computer occurs after a lapse threshold and before a timeout threshold.

11. A method according to claim 2 comprising a plurality of repetitions of steps [a], [b] and [c] for each test-taker thereby to receive a plurality of response times for each test-taker at the server computer and thereby to assign a response type to each of the plurality of response times for each test-taker; and wherein determining the score for each test-taker is based at least in part on the plurality of response times and the corresponding plurality of response types for each test-taker.

12. A method according to claim 11 wherein determining the score comprises, for each test-taker, determining the score to be a mean of the response times for the test-taker which have corresponding valid response types.

13. A method according to claim 11 wherein determining the score comprises, for each test-taker:
determining a baseline response time for the test-taker, the baseline response time being indicative of a response-time characteristic of the test-taker;
calculating a baseline-adjusted response time by subtracting the baseline response time from the response time; and
determining the score based at least in part on the baseline-adjusted response time and the response type.

14. A method according to claim 13 wherein determining a baseline response time for the test-taker comprises receiving a baseline response time from one or more of: a user, a test-taker, a database, a client computer, a server computer, or a computer network.

15. A method according to claim 13 wherein determining a baseline response time for the test-taker comprises:
repeating, for at least two stimulus-response rounds of the test, the steps of:
[b] receiving a response time for each test-taker, and
[c] analyzing the response time for each test-taker;
identifying a subset of the analyzed response times having a valid response type;
determining the mean value of all response times within the identified subset; and
assigning the mean value thus determined to the baseline response time.

16. A method according to claim 15 wherein identifying a subset of received response times comprises identifying all received response times.

17. A method according to claim 15 wherein identifying a subset of received response times comprises identifying all received response times with durations shorter than a baseline-response selection threshold.

18. A method according to claim 17 wherein the baseline-response selection threshold comprises the top-ten percent of shortest response times.

19. A method according to claim 13 wherein determining a baseline reaction time for each test-taker comprises receiving a nominal response time, the nominal response time being indicative of typical response times of individuals within a population to which the test-taker belongs.

20. A method according to claim 19 wherein receiving a nominal response time comprises one or more of: applying a nominal-response function to nominal-response characteristic data associated with the test-taker, or applying a look-up table to nominal-response characteristic data associated with the test-taker.

21. A method according to claim 20 wherein the nominal-response characteristic data associated with the test-taker comprises one or more of: age, gender, sleep history, and activity data.

22. A method according to claim 12 wherein determining the score, for each test-taker, comprises: assigning the test-taker a rank, as among all test takers, based at least in part on the mean response time for the test-taker, and determining the score based at least in part on the rank.

23. A method according to claim 13 wherein determining the score, for each test-taker, comprises: assigning the test-taker a rank, as among all test takers, based at least in part on the plurality of baseline adjusted response times for each test taker, wherein a higher rank is correlated with a lower difference.

24. A method according to claim 11 wherein determining the score for each test-taker comprises, for each test-taker, determining a weighted response value for each response based on the response type and response time, and summing all the weighted response values to create a weighted sum, the score then based at least in part on the weighted sum.

25. A method according to claim 24 wherein valid response types are assigned a weight score with a positive value, and invalid response types are assigned a weight score with a negative value, and the weighted response value for each response set to the weight score of the corresponding response type.

26. A method according to claim 11 wherein determining the score for each test-taker comprises, for each test-taker, applying a penalty to the weighted sum based on a standard deviation of the response times for the test-taker which have corresponding valid response types.

27. A method according to claim 1 comprising communicating at least one score from the server computer to at least one of the client computers over the communication network.

28. A method according to claim 1 comprising communicating at least one response type from the server computer to at least one of the client computers over the communication network.

29. A method according to claim 1 wherein communicating at least one score from the server to at least one of the client computers over the communication network comprises communicating a score assigned to a response time received from a first client computer to a second client computer, the first and second client computers not being the same client computer.

30. A method according to claim 1 wherein the stimulus-response test comprises a psychomotor vigilance test.

31. A method according to claim 2 comprising, for the plurality of the test-takers, ranking the response times having valid response types in order from fastest to slowest.

32. A method according to claim 31 wherein determining the score comprises, for each test-taker, if the test-taker's response time has a valid response type, then determining the score for the test-taker based on a rank of the response time of the test-taker among the response times having valid response types.

33. A method for scoring a stimulus-response test administered over a distributed computing environment, the method comprising:
[a] administering a stimulus-response test from a server computer to a plurality of test-takers via one or more client computers connected to the server computer over a communication network, wherein administering the stimulus-response test comprises, for each client computer, causing the client computer: to present a stimulus trigger; and to receive, from each test-taker taking the stimulus-response test at the client computer, an acknowledgement input responsive to the stimulus trigger;
[b] receiving a response time for each test-taker at the server computer, wherein, for each test-taker, the response time comprises a time difference between: the presentation of the stimulus trigger by the client computer at which the test-taker is taking the stimulus-response test; and the receipt of the acknowledgement input by the client computer at which the test-taker is taking the stimulus-response test;
[c] receiving response latency correction data corresponding to each of the test-takers at the server computer, the response latency correction data, for each test-taker, based on characteristics of the client computer on which the test-taker is taking the stimulus-response test;
[d] determining a score for each test-taker at the server computer based at least in part on both the response time of the test-taker and the response latency correction data corresponding to the test-taker.

34. A method according to claim 33 wherein the response latency correction data corresponding to each of the test-takers comprises a latency parameter associated with a client computer.

35. A method according to claim 34 wherein determining a sore for each test-taker comprises subtracting the latency parameter as on offset from the response time received from the test-taker.

36. A method for scoring a stimulus-response test administered over a distributed computing environment, the method comprising:
[a] administering a stimulus-response test from a server computer to a plurality of test-takers via one or more client computers connected to the server computer over a communication network, wherein administering the stimulus-response test comprises administering a plurality of stimulus-response rounds and wherein administering each stimulus-response round comprises, for each client computer, causing the client computer: to present a corresponding stimulus trigger for the round; and to receive, from each test-taker taking the stimulus-response test at the client computer, an acknowledgement input for the round responsive to the stimulus trigger for the round;
[b] for each stimulus-response round, receiving a response time for the round for each test-taker at the server computer, wherein, for each test-taker, the response time for the round is based at least in part on a time difference between: the presentation of the stimulus trigger for the round by the client computer at which the test-taker is taking the stimulus-response test; and the receipt of the acknowledgement input for the round by the client computer at which the test-taker is taking the round of the stimulus-response test;
[c] determining a composite score for each test-taker at the server computer by applying a composite score metric to the response times of the test-taker for at least two stimulus-response rounds.

37. A method according to claim 36 wherein applying the composite score metric comprises applying a ranking function to the received response times for each test taker for at least two stimulus-response rounds.

38. A method according to claim 37 wherein the ranking function assigns a rank based upon one or more of: the response time, and the order in which the response time is received at the server computer.

39. A method according to claim 36 wherein the composite score metric comprises determining the fastest potential response time for a test-taker based upon the response times for the test-taker for at least two stimulus-response rounds.

40. A method according to claim 39 wherein determining the fastest potential response time for a test-taker comprises determining the average of the top ten percent of response times for the test-taker.

41. A method according to claim 36 wherein the composite score metric comprises calculating the sum of all response times for a test taker for at least two stimulus-response rounds.

42. A method according to claim 36 wherein the composite score metric comprises centering the mean of all response times for a test taker for at least two stimulus-response rounds.

43. A method according to claim 36 wherein centering the mean of all response times for a test taker comprises finding the mean value of all response times for the test taker and subtracting the mean value from each of the response times.

44. A method according to claim 36 wherein the composite score metric comprises determining the average response time for a test taker for response times for at least two stimulus-response rounds.

45. A method according to claim 44 wherein determining the average response time comprises determining a weighted average response time.

46. A method according to claim 45 wherein the weight for each response time is based on a magnitude of an inter-stimulus interval preceding the response time.
